(19) United States
(12) Patent Application Publication
(10) Pub. No.: US 2007/0186573 A1
(43) Pub. Date: Aug. 16, 2007

(54) Methods of and systems for dual drive HVAC compressor controls in automotive vehicles

(76) Inventors: Lawrence P. Ziehr, Clarkston, MI (US); Mark D. Nemesh, Troy, MI (US); Gregory A. Major, Farmington Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/356,345

(22) Filed: Feb. 16, 2006

(51) Int. Cl. F25B 49/00; F25B 27/00; B60H 1/32

(52) U.S. Cl. 62/236; 62/228.1; 62/230; 62/244

(57) ABSTRACT

The efficiency of a dual drive compressor for an air conditioner in a hybrid vehicle having an internal combustion engine and an electric motor is enhanced by calculating compressor load for the air conditioner and then determining allowable engine-off time for the internal combustion engine. Once the engine is turned off, a time counter is started. The engine is thereafter turned on once the time counter indicates that an allowable engine-off time has elapsed. During the cycle, the engine is forced to remain on until minimum “engine-on” time has elapsed. The A/C compressor load is calculated using compressor capacity, engine speed, and/or air conditioner high pressure as input parameters.

### FIELD OF THE INVENTION

The present invention is directed to methods of and systems for controlling dual drive HVAC compressors used in automotive vehicles. More particularly, the invention is directed to such methods and systems used in hybrid vehicles.

### BACKGROUND OF THE INVENTION

A dual drive compressor is a device that utilizes both mechanical and electrical power in order to pump A/C (Air Conditioning) refrigerant in a vehicle, thereby satisfying A/C system requirements. A dual drive compressor is typically used in hybrid vehicles because in hybrids the mechanical engine is turned off when, for example, the vehicle stops. A dual drive compressor allows for operation of the compressor even during an engine-off event by using an electric motor to power the compressor when the engine is off because without a dual drive compressor, a hybrid engine's engine off operation greatly limits the effectiveness of an A/C system.

In theory these limitations could be overcome by using a fully electrical compressor to maintain proper HVAC (Heating, Ventilation and Air Conditioning) system performance, but batteries currently used in hybrids normally lack the capacity to provide adequate performance. This is especially true for mild hybrid vehicles where the amount of power and energy stored in the battery connected to the motor generator is limited. Generally, mild hybrids have no or very limited ability to propel a vehicle by using only the vehicle's electric drive motor.

There are two known current solutions to minimize an engine off event's limitations on the operation of hybrid vehicles. These methods determine engine off allowable time in warm climate conditions.

The first method uses a 42 Volt mild hybrid with an electric motor mounted in the transmission. The motor is capable of simultaneously starting the engine and starting the initial movement of a vehicle until the engine starts and is capable of propelling the vehicle. On request, the HVAC control send an “engine-on” request based on the difference between desired duct discharge air temperature and actual duct temperature sensor measurement. This approach utilizes a belt alternator starter to start the engine wherein a motor generator is connected to an engine accessory drive that drives accessories, adds torque during vehicle acceleration and provides limited regenerative braking.

In the second method, the HVAC control is equipped with an “ECO” button by which a user chooses either maximum comfort or maximum fuel economy, relying on a lookup table of maximum engine time off vs. ambient temperature. The lookup table is not tied to the actual A/C system capacity in use, but instead is conservatively calibrated assuming maximum A/C system load.

Typically, current HVAC controls cannot request an “engine-on” event in any of the current systems. If such were the case, the HVAC control would have to be redesigned to be compatible with new on board diagnostic systems. Because of this typical setup, current HVAC controllers are decoupled from the engine controller for requesting an engine on/off.

### SUMMARY OF THE INVENTION

In view of the aforementioned considerations, the present invention is directed to methods of control and apparatus for controlling dual drive compressors driven by both an engine and electric motor wherein the method and apparatus perform an “engine-on” request to maintain acceptable HVAC system performance in hybrid vehicles.

Preferably, this is accomplished by a controller which is configured to perform a method of controlling a dual drive compressor in a hybrid vehicle, the method including:

I) calculating A/C compressor load;

II) determining allowable “engine-off” time;

III) starting a time counter once the engine turns off;

IV) turning engine on once the counter indicates that allowable “engine-off” time elapsed, and

V) forcing the engine on until minimum engine-on time has elapsed.

Preferably, in a mild hybrid vehicle, the A/C compressor load is calculated based on information on compressor capacity, engine speed, and/or A/C high pressure, while determining allowable “engine-off” time based on data on A/C compressor load. In the method the counter counts to allowable engine-off time. Minimum “engine-on” time is calculated from ambient temperature and/or engine air intake temperature.

In a further aspect, the invention is directed to the controller itself, and to a vehicle, for example, a hybrid vehicle, which contains such a controller.

The controls for the present invention are useable, for example, in mild hybrid vehicles generally and mild HEVs (Hybrid Electric Vehicles) with dual-drive A/C compressors.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a perspective view of a hybrid vehicle having a controller according to the present invention connected to an air conditioner;

FIG. 2 is a schematic diagram showing a controller connected to input/outputs and to other controllers;

FIG. 3 is an exemplary flow chart of control steps in accordance with the principles of the present invention;

FIG. 4 is a logic flow chart illustrating the control steps of FIG. 3; and

FIG. 5 is a schematic view exemplarily of a control system for a dual drive compressor control.

### DETAILED DESCRIPTION

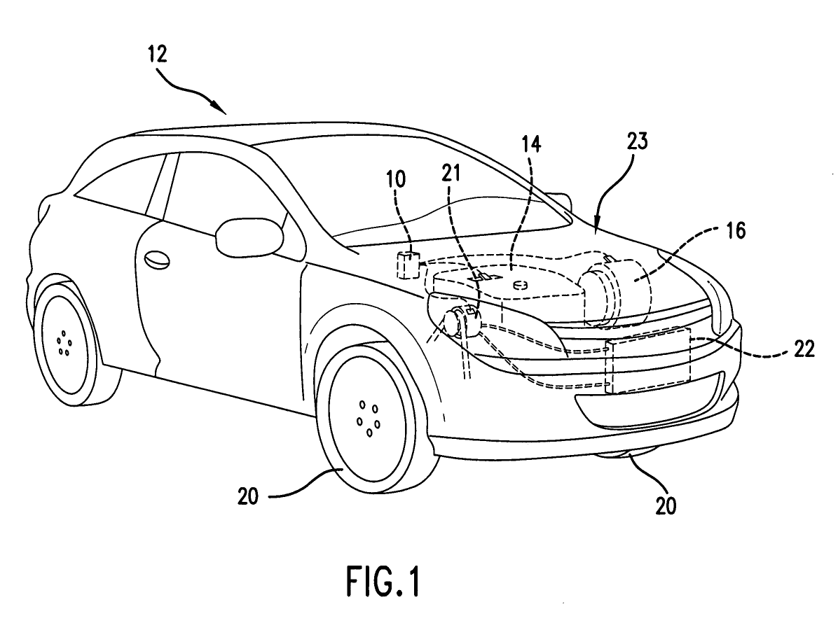

Referring now to FIG. 1, a controller 10 in a hybrid vehicle 12 selectively connects an engine 14 or an electric traction motor 16 to the drive wheels 20 of the hybrid vehicle. The controller 10 also operates an air conditioning system including a compressor 21 and a condenser 22. The controller 10 is mounted at any convenient location in the vehicle 12 but typically is mounted in the engine compartment 23. Related controllers, such as cabin temperature controllers and HVAC controllers, are installed in the cabin, for example, within the instrument panel, under the seats or in the trunk.

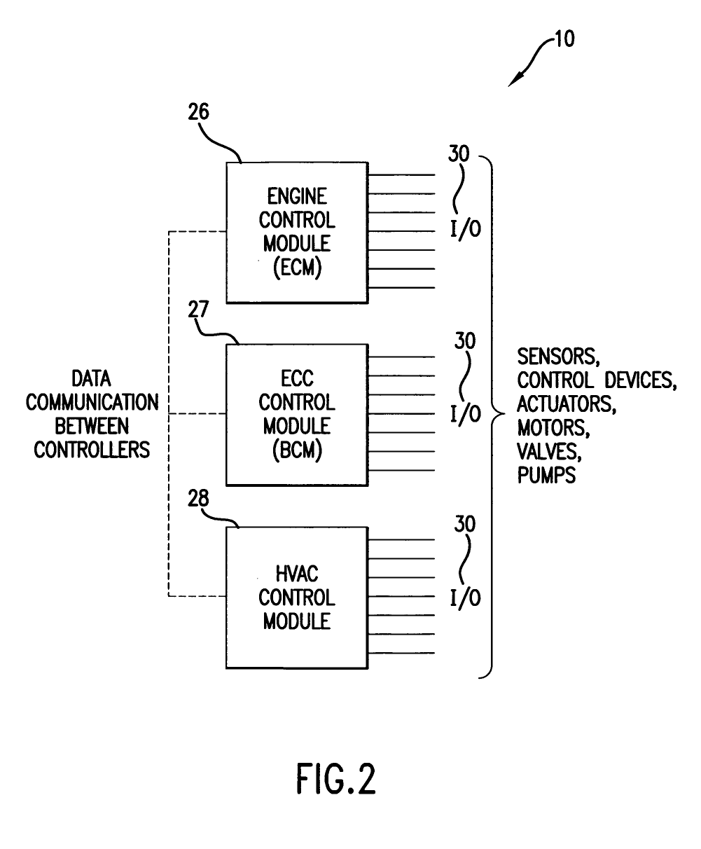

FIG. 2 illustrates a typical connective arrangement for the controller 10 of the invention to inputs and outputs (I/Os) 30 and between other controller modules. The controller 10 in a vehicle 12 generally comprises an engine control module (ECM) 26, a body control module (BCM) 27 and a HVAC control module 28, each typically having electrical connections for inputs and outputs, electric signal conditioning, a communications channel to talk with other vehicle controllers, and a processor to run control logic.

As is evident from FIG. 2, the methods of the present invention are achieved by minimal control integration, resulting in an overall reduction in control complexity, while maintaining On-Board Diagnostic II (OBDII) requirements by using a controller according to the invention. This means, for example, that compressor control can still reside in an OBDII device, where as a conventional HVAC system, it would not require any input other than an initial compressor request.

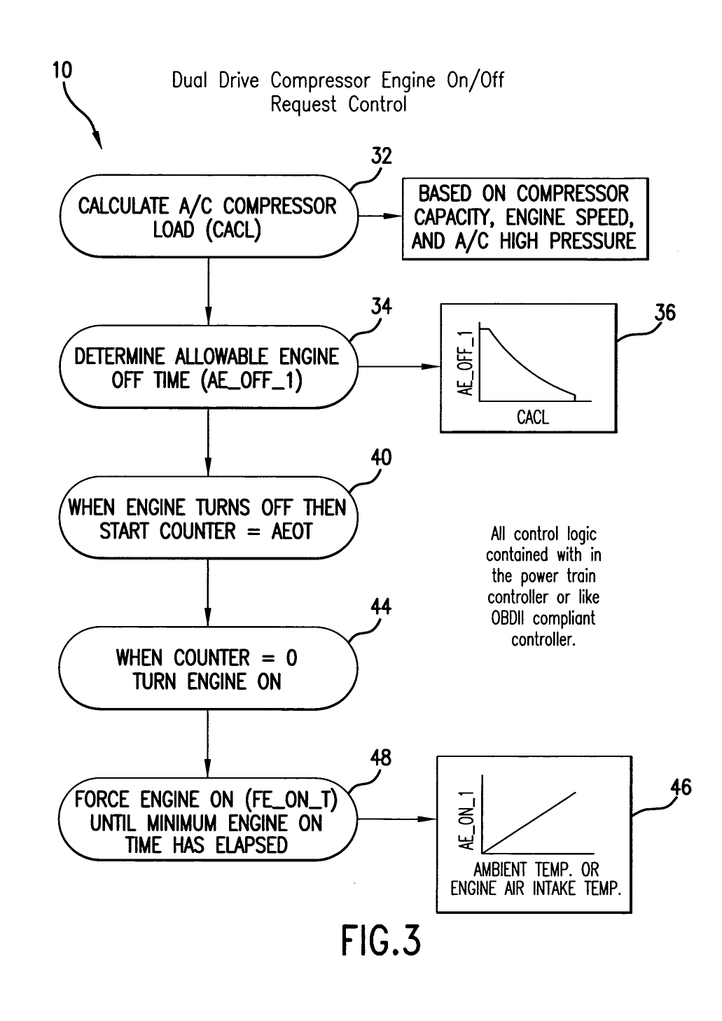

FIG. 3 is an exemplary flow chart of preferred control steps in accordance with the principles of the present invention. Preferably, this embodiment is directed to a dual drive compressor engine on/off request control arranged to perform the following steps:
I) A first calculating step 32 is performed in which A/C compressor load (CACL) is calculated based on parameters such as compressor capacity, engine speed, and/or A/C high pressure.
II) An engine-off time step 34 is performed during which allowable engine-off time (AE_OFF_t) is calculated as a function of the aforementioned CALC step 32, as is seen in the graph 36. The graph 36 illustrates that typically lower compressor loads allow for longer allowable engine off time; however, specific values for the graph 36 are dependent on a large number of factors/parameters such as vehicle type and vehicle operating conditions, for example, terrain, temperature and humidity.
III) In step 40, once the engine turns off, a counter is started from the (AE_OFF_t) time.
IV) In step 44, once the AEOT counter reaches zero, the engine 14 is turned on and is forced to remain on until a minimum “engine-on” (FE_ON_t) time has elapsed.
V) As is seen in step 48, FE_ON_t time is a function of ambient temperature and/or engine air intake temperature and FE_ON_t time, as seen in graph 46, increases with these temperatures. The graph 46 also demonstrates that lower ambient temperature and/or engine air intake temperature typically allows for shorter minimum “engine-on” time.

The controller 10 controls strategy of the “engine-off” controller in other configurations of the invention and can include a more complex strategy with, for example, the addition of more I/Os. Automatic controls and the addition of sensors to regulate and/or measure, for example, air temperature, HVAC Module outlet temperature, and/or cabin humidity, enables implementation of even more sophisticated control strategies that further extends “engine-off” time over a wider range of ambient temperatures and humidity. The more information the controller couples with an appropriate control logic, the more it is possible to optimize the “engine-off” time.

The following exemplary parameters are inserted into control logic used in a processor of the controller 10 of the invention, which is run for example, in MATHCAD®):
1) Calculated Compressor Torque (CCT);
2) Compressor Speed (CRPM);
3) Maximum Motor Power (MMP) for the compressor motor;
4) Engine Idle Off (EIO);
5) Measured Compressor Current (MCA);
6) System Voltage (SV);
7) Estimated Compressor Power Usage (ECP);
8) A/C Load Factor (ACLF) which is equal to (ECP−MMP)/MMP, and
9) Allowable compressor time off (M) which is a function of A/C load factor (PF) and is equal to A×(ACLF)²+B×ACLF+C, wherein A, B and C are regressions of power factor and time.

The Measured Compressor Power (MCP) determined by the controller 10 is equal to (MCA×SV).

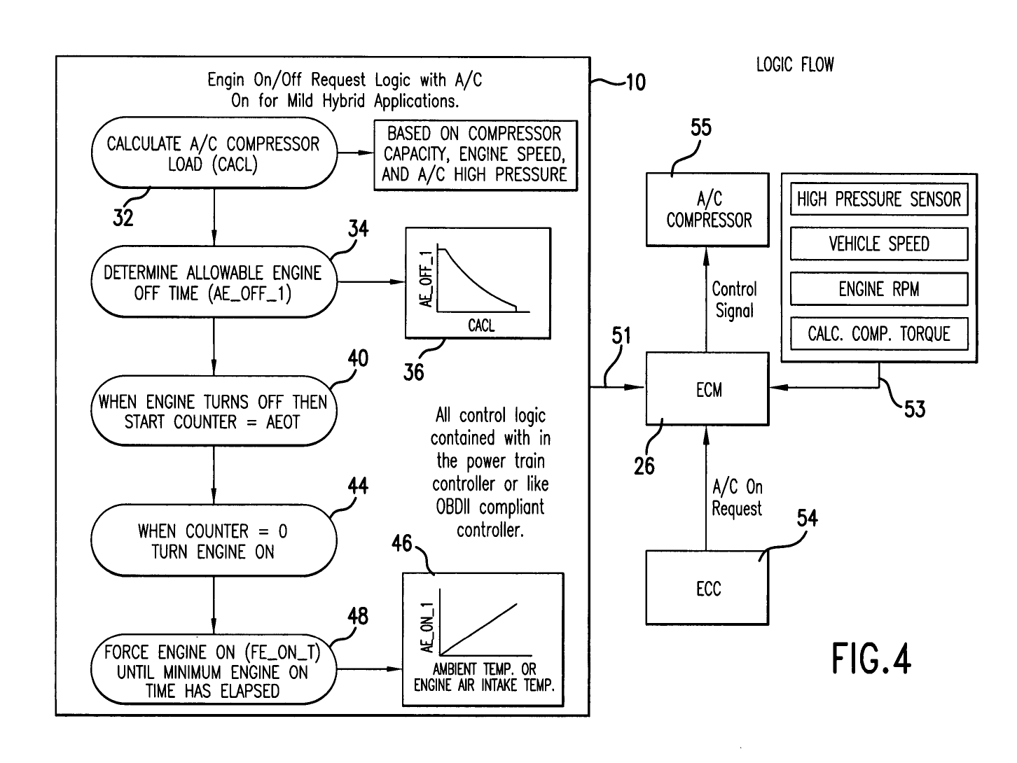

FIG. 4 is a logic flow chart illustrating the flow of information among controllers, etc., including the flow of the information 51 for the control steps 32, 34, 40, 44 and 48 of the invention discussed with respect to FIG. 3. The information from the controller 10 is provided to the engine control module (ECM) 26 (FIG. 2) that also receives information 53, such as vehicle speed, engine RMP, calculated compression torque, high pressure sensor information, as well as information from the electronic cabin control (ECC) 27 (FIG. 2) such as, for example, air conditioning on request.

Fundamental inputs into the engine control module (ECM) 26 for manual HVAC controls are system compression, engine speed, and discharge pressure. The inputs to the ECM 26 is used to estimate compressor capacity, which corresponds to the cooling load of the HVAC system. The calculation of load determines allowable engine-off time. High loads result in shorter engine-off times than low loads. The ECM 26 then sends a signal to the A/C compressor 55 to control the A/C compressor accordingly.

The compressor passes power back to the electronic cabin control (ECC) 27 whereby improvements in system efficiencies are achieved. For example, there are improvements in vehicle fuel efficiency, and HVAC efficiency when data is returned to ECC, and its implementation, for example, on Mild/BAS type hybrid programs require little vehicle integration. For example, no new I/O (input/output) is required for ECC; no new buttons are required for ECC; no HVAC engine on request is required; the arrangement works on both manual and auto HVAC systems, and the arrangement allows for carry over of current HVAC system, e.g., a specific compressor change is not required for the system to operate effectively.

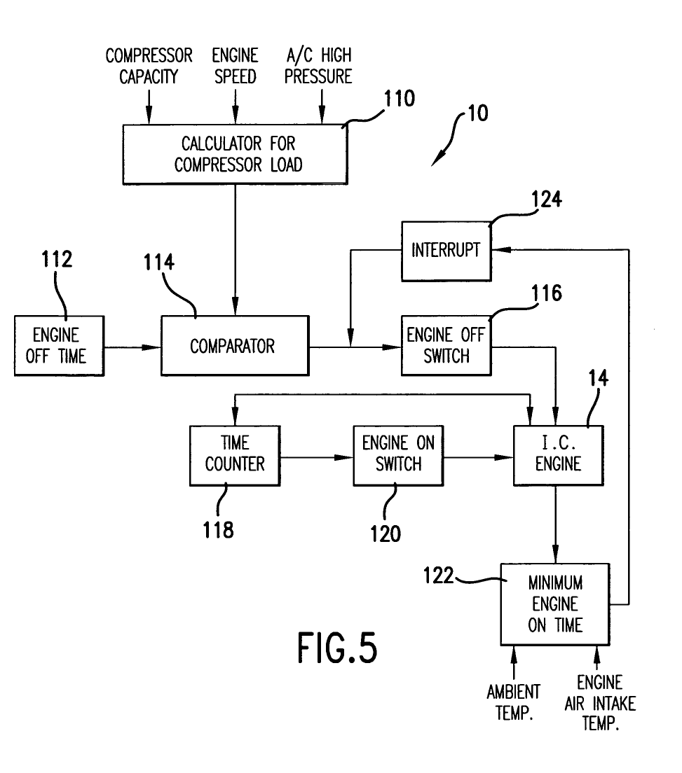

FIG. 5 is exemplary of a control system 10 configured in accordance with the present invention wherein a calculator 110 calculates compressor load from inputs of compressor capacity, engine speed and A/C high pressure. The compressor load is compared to a selected “engine-off” time 112 by a comparator 114 which activates an “engine-off” switch 116 to shut down the IC engine 14. When the IC engine 14 shuts down, a time counter 118 is started that activates an “engine-on” switch 120 to restart the IC engine 14. When the IC engine 114 restarts a minimum “engine-on” timer 122 is started which overrides the engine-off switch 116 with an interrupt 124 until the minimum engine on time has elapsed. The “engine-on” time is computed as a function of ambient temperature and air intake temperature.

From the foregoing description, one skilled in the art can easily ascertain the essential characteristics of this invention, and without departing form the spirit and scope thereof, can make various changes and modifications of the invention to adapt it to various usages and conditions.

We claim:

1) A method of controlling a dual drive compressor for an air conditioner in a hybrid vehicle having an internal combustion engine and an electric motor, the method comprising:
I) calculating compressor load for the air conditioner,
II) determining allowable engine-off time for the internal combustion engine,
III) starting a time counter once the engine turns off,
IV) turning the engine on once the time counter indicates that an allowable engine-off time has elapsed, and
V) forcing the engine to remain on until minimum engine on time has elapsed.

2) The method according to claim 1, wherein the A/C compressor load is calculated using compressor capacity, engine speed, and/or air conditioner high pressure as input parameters.

3) The method according to claim 1, wherein allowable engine-off time is determined using air conditioner compressor load.

4) The method according to claim 1, wherein the counter starts from zero and counts to the allowable engine-off time.

5) The method according to claim 1, wherein minimum engine-on time is calculated from ambient temperature and/or engine air intake temperature.

6) The method according to claim 1, wherein the hybrid vehicle is a mild hybrid vehicle.

7) The controller for a dual drive compressor in a hybrid vehicle that operates according to the method of claim 1.

8) A hybrid vehicle in combination with the controller of claim 8.

9) A control system for a dual drive compressor for an air conditioner in a hybrid vehicle having an internal combustion engine and an electric motor, the controller comprising:
I) a calculator for calculating compressor load for the air conditioner,
II) a comparator for determining allowable engine-off time for the internal combustion engine by comparing engine-off time to calculated compressor load,
III) a first switch for starting a time counter once the engine turns off,
IV) a second switch for turning the engine on once the time counter indicates that an allowable engine-off time has elapsed, and
V) a timer connected to the engine for forcing the engine on until minimum engine on time has elapsed.

10) The system according to claim 9, wherein the calculator for determining A/C compressor load has as inputs compressor capacity, engine speed, and/or air conditioner high pressure.

11) The system according to claim 9, wherein allowable engine-off time is determined using an input indicative of air conditioner compressor load.

12) The system according to claim 9, wherein a counter in the controller starts from zero and counts to allowable engine-off time.

13) The system according to claim 9, wherein minimum engine-on time is calculated from temperature inputs to the controller for ambient temperature and/or engine air intake temperature.
